(19) United States
(12) Patent Application Publication
(10) Pub. No.: US 2011/0079635 A1
(43) Pub. Date: Apr. 7, 2011

(54) REMOVAL OF BRAZED METAL SHEETS

(76) Inventors: Andreas Dumm, Berlin (DE); Peter Möllenbeck, Berlin Tempelhof-Schoneberg (DE); Ingo Reinkensmeier, Frondenberg (DE)

(21) Appl. No.: 12/898,029

(22) Filed: Oct. 5, 2010

(30) Foreign Application Priority Data
Oct. 6, 2009 (EP) 09012637.6

(51) Int. Cl. B23K 1/018

(52) U.S. Cl. 228/264

(57) ABSTRACT

A process including local heating of a brazing point in order to remove an integrally brazed component from a structural part is provided. The brazing point joins a metal sheet in the interior of a cavity to a structural part. The process makes the removal of the metal sheet from the cavity much easier compared to the existing mechanical removal. A plasma source or an induction source may be used for heating the filler metal.

### CROSS REFERENCE TO RELATED APPLICATIONS

This application claims priority of European Patent Office application No. 09012637.6 EP filed Oct. 6, 2009, which is incorporated by reference herein in its entirety.

### FIELD OF INVENTION

The invention relates to the removal of brazed metal sheets from a structural part.

### BACKGROUND OF INVENTION

Brazing is a joining technique for bonding components to structural parts. This is the case for metal sheets for turbine blades or vanes, which are brazed on in the root and also in the head (if present).

During refurbishment, i.e. after the turbine blades or vanes have been used, these metal sheets have to be removed. This takes place in a lengthy process by mechanical removal of the metal sheet on a machining machine.

### SUMMARY OF INVENTION

It is therefore an object of the invention to solve the problem mentioned above.

The object is achieved by a process as claimed in the claims.

The dependent claims list further advantageous measures, which can be combined with one another to obtain further advantages.

During the process, the brazing point is heated locally.

### BRIEF DESCRIPTION OF THE DRAWINGS

FIGS. 1, 2, 3 show a structural part with a brazing point,

FIG. 4 shows an arrangement for removing the brazed structural part, and

FIG. 5 shows a turbine blade or vane.

The figures and the description represent only exemplary embodiments of the invention.

### DETAILED DESCRIPTION OF INVENTION

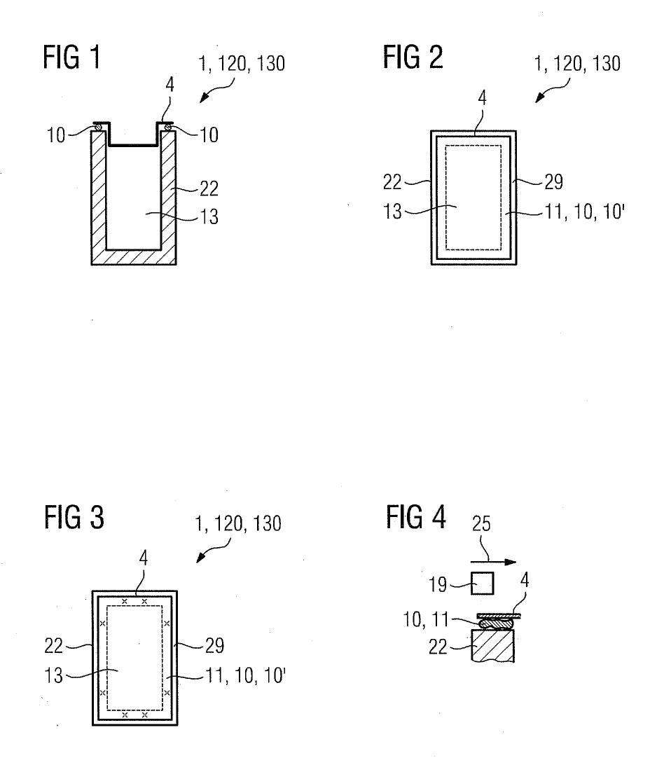

FIG. 1 shows a structural part 1, in particular a turbine blade or vane 120, 130, having a cavity 13, which 13 is delimited by walls 22.

Above the cavity 13, a component 4, in particular a metal sheet 4, is brazed onto the wall 22 or onto the end faces 29 of the wall 22 of a structural part 1, 120, 130.

The brazed joint is preferably a continuous brazed seam 11, such that the metal sheet 4 is sealed off in an airtight mariner with respect to the cavity 13 in the region of the brazed seam 11.

A brazed seam 11 is not punctiform and its length is preferably at least five times its width.

FIG. 2 shows a plan view of FIG. 1, and in FIG. 2 the contour profile of the cavity 13, which can run in any desired way, is indicated by dashed lines.

This is preferably a plan view of an underside 29 of a platform 403 of a guide vane 130.

FIG. 2 shows that the metal sheet 4 rests on the upper end face 29 of the wall 22.

A filler metal 10, 10′, preferably a filler metal which is completely circulatory in the form of a brazed seam 11, is present between the profile indicated by dashed lines and the outer profile of the metal sheet 4.

It may likewise be possible for the metal sheet 4 to be fixed, in particular welded, at some points before it is brazed on (see X in FIG. 3), so that the metal sheet 4 is stabilized during brazing.

The metal sheet 4 is preferably brazed on by firstly spot-welding the metal sheet 4 at points X, then preferably applying a brazing paste around the outer edge of the metal sheet 4 and then heating it in a furnace and by drawing the filler metal into the gap between the metal sheet 4 and the structural part 1, 120, 130 by capillary action.

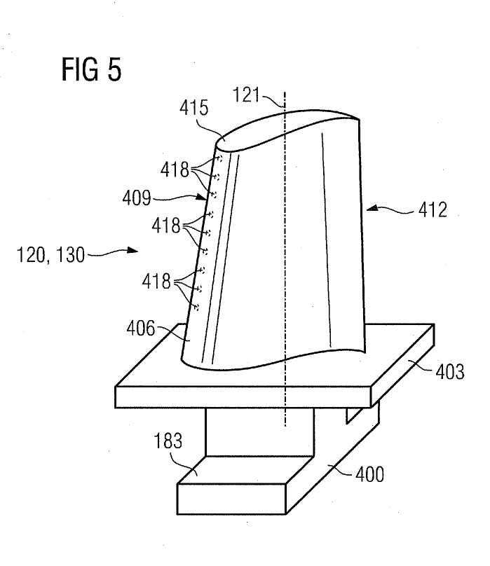

FIG. 4 schematically shows how the brazing point 10 is heated locally, i.e. by means of a heating source.

Locally means that not all of the structural part 1, 120, 130 is heated, such that the structural part 120, 130 is merely heated locally at the brazing point 10, 10′ or locally at the brazed seam 11.

The heating source 19 used can preferably be a plasma, an induction source or a laser.

The filler metal is not directly accessible from above.

The detachment of the metal sheet 4 can be assisted by the action of manual force or by removal of the molten filler metal by suction, in particular if welding points (x) are present.

The filler metal 10, 11 is gradually heated, and the bond between the component 4 and the structural part 1, 120, 130 is gradually released until it is completely removed.

FIG. 5 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as structural parts for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal structural part.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from structural parts 120, 130 (e.g. by sand-blasting). Then, the corrosion and/or oxidation layers and products are removed. If appropriate, cracks in the structural part 120, 130 are also repaired. This is followed by recoating of the structural part 120, 130, after which the structural part 120, 130 can be reused.

The blade or vane 120, 130 may be hollow or solid in form. If the blade or vane 120, 130 is to be cooled, it is hollow and may also have film-cooling holes 418 (indicated by dashed lines).

1.-10. (canceled)

11. A process for removing an integrally brazed component from a structural part, comprising:
heating locally, a brazing point or a brazed seam between the component and the structural part,
wherein the brazed seam includes a length that is at least five times a width of the brazed seam.

12. The process as claimed in claim 11, wherein the structural part is a turbine blade or vane.

13. The process as claimed in claim 11, further comprising applying a force to the component during the heating of a filler metal which is the brazing point or brazed seam.

14. The process as claimed in claim 11, wherein a plasma source is used for heating the filler metal.

15. The process as claimed in claim 11, wherein an induction source is used for heating the filler metal.

16. The process as claimed in claim 11, wherein the component is a metal sheet.

17. The process as claimed in claim 11, wherein the component is fixed to the structural part at a plurality of points.

18. The process as claimed in claim 17, wherein the component is welded to the structural part at the plurality of points.

19. The process as claimed in claim 11, wherein only one brazed seam is present.

20. The process as claimed in claim 11, wherein only the brazing point is present.

21. The process as claimed in claim 11, wherein the brazing point or the brazed seam is heated locally in succession such that a bond between the component and the structural part is gradually released.

22. The process as claimed in claim 11, wherein the structural part is a solid structural part.

23. The process as claimed in claim 22, wherein the structural part is a solid hollow structural part.
